(19) United States
(12) Patent Application Publication
(10) Pub. No.: US 2006/0147596 A1
(43) Pub. Date: Jul. 6, 2006

(54) Process for the stabilization of 2-acetyl-1pyrroline, the basmati rice flavourant

(76) Inventors: Pullabhatla Srinivas, Karnataka (IN); Guruguntla Sulochanamma, Karnataka (IN); Bashyam Raghavan, Karnataka (IN); Kambadoor Nagarajarao Gurudutt, Karnataka (IN)

Correspondence Address: LADAS & PARRY, 26 WEST 61ST STREET, NEW YORK, NY, 10023, US

(21) Appl. No.: 10/540,196

(22) PCT Filed: Dec. 20, 2002
(86) PCT No.: PCT/IB02/05529

§ 371 Date: Feb. 21, 2006

(51) Int. Cl. A23L 1/22

(52) U.S. Cl. 426/534

(57) ABSTRACT

The present invention provides an improved process for the stabilization of 2-acetyl-1-pyrroline, a basmati aroma producing principle, the said process comprising steps of: dissolving a binder in water containing few drops of an emulsifier, adding an ethanol solution of 2-acetyl-1-pyrroline, homogenizing for a time period of 3 to 5 minutes, and drying the solution to obtain the stabilized flavor 2-acetyl-1-pyrroline in a dispersible dry powder form.

### TECHNICAL FIELD

The present invention relates to ‘An improved process for stabilization of 2-acetyl-1-pyrroline, the principle aroma component of basmati and other varieties of scented rice and also of processed cereal and grain products’.

The main uses of the present invention are (i) making the basmati rice flavouring in easily dispersible powder form and (ii) imparting stability to an otherwise labile aroma chemical. These products are of value in the art of application of flavor to foodstuffs like rice and bakery products and related preparations.

### BACKGROUND AND PRIOR ART REFERENCES

Scented rice is one of the varieties of rice¹⁻⁶ having a characteristic, strong aroma when cooked. Varieties of Basmati in Southeastern Asia, Della in America, Milagrosa in Philippines, ‘Khao Dawk Mali 105’ in Thailand, ‘Seratus Malam’ in Indonesia and Heiri in Japan are the major scented rice varieties. In certain parts of the world where these varieties are cultivated, scented rice is highly desired and sometimes used for special purposes.

2-acetyl-1-pyrroline was first identified in rice by Buttery et al⁷⁻⁸. in 1982. Its odor is described as that of cooked rice and popcorn-like. A method of its synthesis is described starting from 2-acetylpyrrole⁹. A method for its quantitative analysis has been developed by Buttery et al¹⁰ and later refined by Tanchotikul et al¹¹. This compound is found in all scented rice varieties in various quantities, which is more than that found in non-scented varieties of rice (table 1).

TABLE 1
LEVEL OF 2-ACETYL-1-PYRROLINE IN SCENTED RICE
VARIETIES⁶

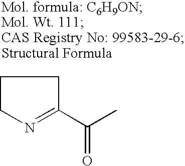

| Rice sample | ppb |
|---|---|
| Malagkit Sungsong (brown) | 760 |
| Basmati 370 (brown) | 610 |
| IR 841-76-1 (brown) | 560 |
| Texas long grain (Bluebell var; polished) | 60 |
| Khao Dawk Mali 105 (brown) | 710 |
| Azucena (brown) | 570 |
| Hieri (brown) | 360 |

2-acetyl-1-pyrroline can be characterized by a comparison of its retention time and MS data with those of a reference standard or reported in literature. The mass spectrum of 2-acetyl-1-pyrroline has major peaks at m/z 111(M^{+,} 5% abundance, 83 (11), 69 (11), 68 (8), 67 (0.2), 55(2), 52 (0.9), 54 (0.2) and 43 (100), 42 (24) and 41 (50). It's Kovats index is 1320 on a Pyrex glass capillary column coated with Carbowax 20M. It's IR spectrum in CCl₄ displays absorption maxima at 1695, 1620, 1435, 1370, 1340, 1250, 1080, 1000, 975 and 940 cm⁻¹.

The compound is a colorless liquid when freshly prepared and purified. It needs to be immediately protected from light and air and preserved in sealed vials under vacuum at temperatures below −20° C. Even at under these conditions it is reported to turn to red on storage and eventually become darker on longer storage. A conjugated polymer, resulting from conjugation of the carbonyl groups with the 5-position of other molecules resulting in a polymeric product, is believed to be the cause of its instability. For this reason the compound is more stable and better preserved in dilute, especially aqueous, solutions wherein it is stable for several months at low temperatures (<−20° C.).

It seems reasonable that 2-acetyl-1-pyrroline has a similar origin to the bread aroma compound 2-acetyl-1,4,5,6-tetrahydropyridine¹². It is assumed that the intermediate formed after decarboxylation of proline residue, is hydrolyzed with the formation of 1-pyrroline. 2-acetyl-1-pyrroline results from the acetylation 1-pyrroline by 2-oxopropanal. Many syntheses of 2-acetyl-1-pyrroline are reported in recent literature¹³⁻¹⁷.

Reference may be made to the patent United States Patent (Richard; Travis, U.S. Pat. No. 6,274,183, 2001), wherein a food coating composition is manufactured from fragrant or scented rices (aromatic rices) by grinding the fragrant rice having a 2-acetyl-1-pyrroline concentration of at least 40 ppb by weight to a predetermined particle size at a predetermined temperature to obtain a food coating composition with uniform adherence to the food product, as well as improved crispness. The resulting food coating composition is claimed to provide a unique and distinct aroma and taste, which is derived from 2-acetyl-1-pyrroline. The main drawback of this is the low levels of the flavor that would be available on dilution in the final product.

Reference may be made to the United States Patents (Duby; Philippe (Prilly, CH); Huynh-Ba; Tuong (Pully, CH) U.S. Pat. No. 5,280,127, 1994; Duby; Philippe; Huynh-Ba; Tuong U.S. Pat. Nos. 5,401,521& 5,446,171, 1995 and Duby; Philippe; Huynh-Ba; Tuong, U.S. Pat. No. 5,512,290, 1996), wherein a powder-form composition of 2-acetyl-1-pyrroline incorporated with a support of maltodextrin and/or cyclodextrin. The composition is prepared by hydrolyzing a 2-(1-alkoxyethenyl)-1-pyrroline with an acid to obtain a reaction medium, adding an equi-molar amount of a base to the reaction medium to obtain a neutralized reaction medium containing 2-acetyl-1-pyrroline, combining maltodextrin and/or cyclodextrin with the neutral reaction medium to obtain a support solution and freeze-drying the support solution to obtain the composition. The main drawback of these methods is that the flavor needs to be released from the precursor by the neutralization with a base and the resultant salt would remain in the product.

Reference may be made to another United States Patent (Buttery; Ronald G.; Ling; Louisa C.; Juliano; Bienvenido O., U.S. Pat. No. 4,522,838, 1985), wherein the compound, 2-acetyl-1-pyrroline and its use in flavoring foods, particularly in imparting a scented rice flavor to foods is disclosed. The drawback of this invention is that the flavorant is used in its salt form and therefore needs to be released prior to use.

### OBJECTIVE OF THE INVENTION

The main objective of the present invention is to provide an improved process for stabilization of 2-acetyl-1-pyrroline, a principle basmati aroma component’, which obviates the aforesaid drawbacks of the processes described in the prior art.

### SUMMARY OF THE INVENTION

Accordingly, the present invention provides, ‘an improved process for stabilization of 2-acetyl-1-pyrroline, the basmati rice flavourant’, which comprises synthesis of 2-acetyl-1-pyrroline by a known method, incorporation of the flavor in a binding material like a gum or starch from a vegetable source in water emulsion using an emulsifier followed by drying the mixture by either vacuum shelf drying at temperatures of 30-60° C. and reduced pressure of 24″ or spray drying at inlet air temp. 140° C., outlet temp. 80° C. and a feed rate of 80 ml/min and obtaining the flavor in an easily dispersible dry powder form for flavoring rice and related products.

### DETAILED DESCRIPTION OF THE INVENTION

Accordingly, the present invention provides an improved process for the stabilization of 2-acetyl-1-pyrroline, a basmati aroma producing principle, the said process comprising steps of:
a) dissolving a binder in water containing few drops of an emulsifier,
b) adding an ethanol solution of 2-acetyl-1-pyrroline to step (a) solution,
c) homogenizing step (b) solution for a time period of 3 to 5 minutes, and
d) drying the homogenized solution of step (c) to obtain the stabilized flavor 2-acetyl-1-pyrroline in a dispersible dry powder form.

In an embodiment of the invention, the binder used in step (a) is from a vegetable source and which is selected from a group consisting of gum acacia, starch or mixtures thereof.

Still another embodiment of the invention, the ratio of 2-acetyl-1-pyrroline and the binder used is in the ratio of 0.1:2000 to 1.0:2000.

Still The process of claim 1, wherein in step (a), the emulsifier used is selected from a group consisting of Tween 80, Tween 60 and more preferably Tween 60.

Yet another embodiment, 2-acetyl-1-pyrroline used is prepared by adopting known methods.

In yet another embodiment drying in step (d) is carried out by vacuum shelf drying or spray drying.

Yet another embodiment, the vacuum shelf drying is performed at reduced pressure of 24″ and at a temperature in the range of 30°-60° C., and spray drying is carried by using a feed rate of 80 ml/min. with an inlet air temperature of 140° C. and outlet temperature of 80° C.

One more embodiment of the invention provides a process, wherein the stabilized flavor obtained is used for flavoring rice and related products.

The following examples are given by way of illustration of the present invention and therefore should not be construed to limit the scope of the present invention.

### EXAMPLE 1

In a typical experiment gum acacia (200 g) was dissolved in 2 l water, a solution of 100 mg of 2-acetyl-1-pyrroline (>95% purity, synthetic sample) in ethanol (3 ml) added, the mixture homogenized for 3 min. and spray-dried under the following conditions: Inlet air temp: 140° C.; outlet temp: 80° C.; feed rate: 80 ml/min. The yield was 90%.

Preparation of Sweetened Basmati Rice

A) Rice (Added Basmati Flavor)

Rice (100 g) was taken, added water (1:3) and cooked for 15 mins. Cooked rice was macerated in a mixer for 1 min. Condensed milk was diluted with water (1:1), and the diluted milk (150 ml) and encapsulated basmati flavor (1% w/w basis on raw rice) were added into the cooked rice and chilled.

B) Natural Basmati Rice

Non-scented rice (100 g) was taken, added water (1:3) and cooked for 15 mins. Cooked rice was macerated in a mixer for 1 min. The condensed milk diluted 1:1 (150 ml) was added to the cooked rice and chilled.

Evaluation of Sweetened Basmati Rice

Rice with added basmati flavor and natural basmati rice were evaluated by sensory analysis on a 10-point scale for quality attributes such as aroma, texture and overall acceptability by a panel of 10 judges. The results reveal that the rice with added flavor is preferred and liked more in comparison to the natural basmati rice with respect to the aroma and overall quality.

### EXAMPLE 2

In a typical experiment binding material (see table below) was dissolved in 2 l water, Tween-60 (4 drops) and a solution of 2-acetyl-1-pyrroline (>95% purity, synthetic sample) in ethanol (3 ml) added, homogenized for 5 min. and vacuum shelf-dried under the following conditions. 30-60° C./24″. The results are tabulated below.

| | Quantity | | Yield of Encapsulated |
|---|---|---|---|
| Binding material | (g) | 2-AP (mg) | Product (g) |
| Gum acacia | 200 | 100 | 143 |
| Starch (HICAP) | 200 | 45 | 89 |
| Gum acacia + | 100 + 100 | 45 | 98 |
| Starch (HICAP) | | | |

### EXAMPLE 3

Also in another experiment starch (200 g) was dissolved in 2 l water, Tween (4 drops) and a solution of 110 mg of 2-acetyl-1-pyrroline (>95% purity, synthetic sample) in ethanol (3 ml) added and the mixture homogenized for 5 min. and spray-dried under the following conditions. Inlet-air temp. 140° C., outlet temp. 80° C. and a feed rate of 80 ml/min. The yield was 162.2 g.

Incorporation of Synthetic Basmati Flavor in to Rice and its Comparison with Natural Basmati Rice

Preparation of Sweetened Basmati Rice

A) Rice (Added Basmati Flavor)

Rice (100 g) was taken, added water (1:3) and cooked for 15 mins. Cooked rice was macerated in a mixer for 1 min. Condensed milk diluted with water (1:1, 150 ml) and encapsulated basmati flavor (1% w/w basis on raw rice) were added into the cooked rice and chilled.

B) Natural Basmati Rice

Rice (100 g) was taken, added water (1:3) and cooked for 15 mins. Cooked rice was macerated in a mixer for 1 min. The diluted condensed milk (150 ml) was added to the cooked rice and chilled.

Evaluation of Sweetened Basmati Rice

Rice with added basmati flavor and natural basmati rice were evaluated by sensory analysis on a 10-point scale for quality attributes such as aroma, texture and overall acceptability by a panel of 10 judges. The results revealed that the rice with added flavor was preferred and liked more in comparison to the natural basmati rice with respect to the aroma and overall quality. However the texture was described as “pasty” in both the samples.

### REFERENCES

1. Volatile Compounds in Foods and beverages, Maarse H, Marcel Dekker, New York, 1991, pp 79-89.
2. Buttery R G, Turnbaugh J G and Ling L C, Contribution of volatiles to rice aroma, J Agric Food Chem., 1988, 36(5), 1006-1009
3. Lin C F, Hsieh, T C.-Y and Hoff B J, Identification and quantification of the “pop- [symbol]
4. Seitz L M, Wright R L, Waniska R D and Rooney L W, Contribution of 2-acetyl pyrroline to odors from wetted ground pearl millet, J Agric Food Chem, 1993,41(6), 955-958.
5. Widjaja R, Craske J D and Wootton M, Comparative studies on volatile components of non-fragrant and fragrant rices, J Sci Food Agric, 1996, 70,151-161.
6. Paule C M and Powers J J, Sensory and chemical examination of aromatic and non-aromatic rices, J Food Sci., 1989, 54(2), 343-346.
7. Buttery R G Ling L C and Juliano B O, 2-acetyl-1-pyrroline: an important aroma component of cooked rice, Chem and Ind, 1982, 958-959
8. Buttery R G, Juliano B O and Ling L C, Identification of rice aroma compound 2-acetyl-1-pyrroline in pandana leaves, Chem and Ind, 1983, 478
9. Buttery R G, Ling L C, Juliano B G and Turnbaugh J G, Cooked rice aroma and 2-acetyl pyrroline, J Agric Food Chem, 1983, 31(4), 823-826.
10. Buttery R G, Ling L C and Mon T R, Quantitative analysis of 2-acetyl pyrroline, J Agric Food Chem, 1986, 34(1), 112-114
11. Tanchotikul U and Hsieh T C.-Y, An improved method for quantification of 2-acetyl-1-pyrroline, a “popcorn”-like aroma, in aromatic rice by high-reasolution gas chromatography/mass spectrometry/selected ion monitoring, J Agric Food Chem, 1991, 39 (5), 944-947.
12. Schieberle P and Grosch W, Identification of the volatile flavour compounds of wheat bread crust—comparison with rye bread crust, Zeitschrift fur Lebensmittel unterschung and Forchung, 1985, 180(6), 474-478.
13. De Kimpe N, Stevens C V and Keppens M, Synthesis of 2-acetyl pyrroline, the principle rice flavour component, J Agric Food Chem, 1993, 41(9), 1458-1461.
14. De Kimpe N and Keppens M, Novel syntheses of the major flavour components of bread and cooked rice, J Agric Food Chem, 1996, 44(6), 1515-1519
15. Hofmann T and Schieberle P, New and convergent synthesis of the important roasty, pop-corn like smelling food aroma compounds, 2-acetyl-1-pyrroline and 2-acetyltetrahydropyridine from their corresponding cyclic α-amino acids, J Agric Food Chem, 1998, 46(6), 2270-2277
16. Hofmann T and Schieberle P, Pencilin acylase-mediated synthesis of 2-acetyl-1-pyrroline and 2-propionyl-1-pyrroline, key roast smelling odourant in Food. Inclusion complexes with β-cyclodextrin and their NMR & MS characterisation, J Agric Food Chem., 1998, 46(6), 616-619.
17. Favino T F, Fronza G, Fuganti C, Fuganti D, Grasselli and Mele A, 2-oxopropanol, hydroxy-2-propanone and 1-pyrroline—important intermediates in the generation of the roast-smelling food flavour compounds, 2-acetyl-1-pyrroline and 2

1. An improved process for the stabilization of 2-acetyl-1-pyrroline, a basmati aroma producing principle, the said process comprising steps of:
a) dissolving a binder in water containing few drops of an emulsifier,
b) adding an ethanol solution of 2-acetyl-1-pyrroline to step (a) solution,
c) homogenizing step (b) solution for a time period of 3 to 5 minutes, and
d) drying the homogenized solution of step (c) to obtain the stabilized flavor 2-acetyl-1-pyrroline in a dispersible dry powder form.

2. The process of claim 1, wherein in step (a), the binder used is from a vegetable source.

3. The process of claim 2, wherein the binder used is selected from a group consisting of gum acacia, starch or mixtures thereof.

4. The process of claim 1, wherein the ratio of 2-acetyl-1-pyrroline and the binder used is in the ratio of 0.1 to 1.0:2000.

5. The process of claim 1, wherein in step (a), the emulsifier used is selected from a group consisting of Tween 80, Tween 60 and more preferably Tween 60.

6. The process of claim 1, wherein 2-acetyl-1-pyrroline used is prepared by adopting known methods.

7. A process of claim 1, wherein in step (d) the drying is performed by vacuum shelf drying or spray drying.

8. A process of claim 7, wherein vacuum shelf drying is performed at reduced pressure of 24″ and at a temperature in the range of 30°-60° C.

9. A process of claim 7, wherein spray drying is carried by using a feed rate of 80 ml/min. with an inlet air temperature of 140° C. and outlet temperature of 80° C.

10. A process of claim 1, wherein the stabilized flavor obtained is used for flavouring rice and related products.
